(19) United States
(12) Patent Application Publication
(10) Pub. No.: US 2013/0059952 A1
(43) Pub. Date: Mar. 7, 2013

(54) PHOSPHO-SUBSTITUTED ALKOXYAMINE COMPOUNDS

(71) Applicants: Rudolf Pfaendner, Rimbach (DE); Michael Roth, Lautertal (DE); Kai-Uwe Schöning, Oberwil (CH); Thomas Weiss, Ilvesheim (DE); Shrirang Bhikaji Hindalekar, Ashokvan (IN)

(72) Inventors: Rudolf Pfaendner, Rimbach (DE); Michael Roth, Lautertal (DE); Kai-Uwe Schöning, Oberwil (CH); Thomas Weiss, Ilvesheim (DE); Shrirang Bhikaji Hindalekar, Ashokvan (IN)

(73) Assignee: BASF SE, LUDWIGSHAFEN (DE)

(21) Appl. No.: 13/520,232

(22) PCT Filed: Jan. 13, 2011
(86) PCT No.: PCT/EP11/50368

§ 371 Date: Nov. 19, 2012

(30) Foreign Application Priority Data
Jan. 15, 2010 (EP) 10150851.3

(51) Int. Cl. C08K 5/5399; C08L 23/12; C07F 9/6571; C08K 5/5313; C07F 9/6574; C07F 9/59

(52) U.S. Cl. 524/103; 546/22; 524/99

(57) ABSTRACT

The invention relates to compounds of the group of so-called sterically hindered amines (HALS) which are substituted by phospho groups. The invention also relates to flame retardant compositions wherein these compounds are added to the polymer substrate.

The invention relates to novel phospho-substituted alkoxyamine compounds and flame retardant compositions that contain the novel phosphor-substituted alkoxyamine compounds.

Flame retardants are added to polymeric materials (synthetic or natural) to enhance the flame retardant properties of the polymers. Depending on their composition, flame retardants may act in the solid, liquid or gas phase either chemically, e.g. as a spumescent by liberation of nitrogen, and/or physically, e.g. by producing a foam coverage. Flame retardants interfere during a particular stage of the combustion process, e.g. during heating, decomposition, ignition or flame spread.

There is still a need for flame retardants with improved efficiency that can be used in different polymer substrates. Increased standards with regard to safety and environmental requirements result in stricter regulations. Particularly known halogen containing flame retardants no longer match all necessary requirements. Therefore, halogen free flame retardants are preferred, particularly in view of their better performance in terms of smoke density associated with fire. Improved thermal stability, less corrosive behaviour, reduced interactions with the polymer substrate and environmental friendliness are further benefits of halogen free flame retardant compositions.

U.S. Pat. No. 5,393,812 discloses polyolefin compositions which are useful as flame retardants by the addition of halogenated hydrocarbyl phosphate or phosphonate ester flame retardants and stabilized against degradation of UV-light with HALS.

EP-A 792 911 discloses the use of alkoxyamine-HALS for improving the flame retardant properties of a polyolefin. WO 99/00450 discloses the use of alkoxyamine-HALS for improving the flame retardant properties.

WO 01/90113 discloses phosphor-substituted hydroxylamine esters as polymerization initiators. WO 2003/082711 discloses flame retardant compositions that contain hydroxylamine esters combined with other flame retardants.

It has surprisingly been found that polymers with excellent flame retardant properties are obtained in the event that compounds of the group of alkoxyamine derivatives of so-called sterically hindered amines (HALS) substituted by phospho groups are added to the polymer substrate.

The invention relates to a compound of the formula

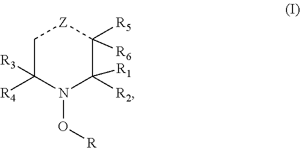

Wherein
R represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁-R₄ represent methyl; or
One of R₁ and R₂ and one of R₃ and R₄ represents methyl; and the other ones of R₁ and R₂ and of R₃ and R₄ represent ethyl;
R₅ and R₆ independently of one another represent hydrogen or methyl;
And Z represents a group of the partial formula:

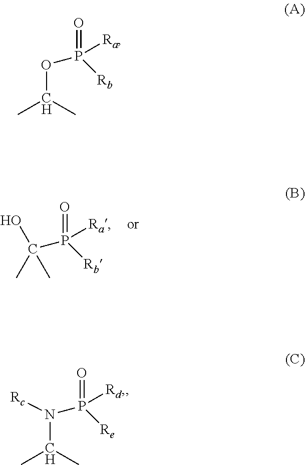

Wherein
Rₐ and Rₐ′ and R_{b} and R_{b}′ independently of one another represent
C₁-C₄alkyl, C₁-C₄alkoxy, phenyl or phenoxy;
R_{c} represents hydrogen or C₁-C₁₂alkyl; and
R_{d} and Rₑ independently of one another represent C₁-C₄alkoxy, phenyl or phenoxy; or together represent C₂-C₈alkylenedioxy; or
Z represents a group of the partial formula

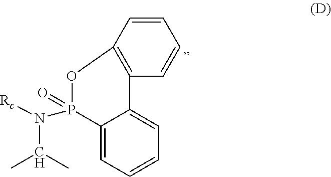

Wherein
R_{c} represents hydrogen or C₁-C₁₂alkyl; or
Z represents a group of the partial formula

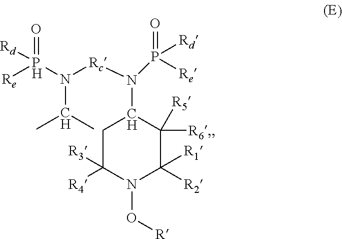

Wherein
R_{c}′ represents C₂-C₈alkylene;
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
One of R₁′ and R₂′ and one of R₃′ and R₄′ represents methyl; and the other ones of R₁′ and
R₂′ and of R₃′ and R₄′ represent ethyl;
R₅′ and R₆′ independently of one another represent hydrogen or methyl; and
R_{d}′ and Rₑ′ independently of one another represent C₁-C₄alkoxy, phenyl or phenoxy; or
R_{d}′ and Rₑ′ together represent C₂-C₈alkylenedioxy; or
Z represents a group of the partial formula

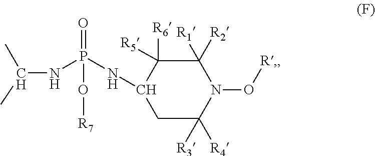

Wherein
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
One of R₁′ and R₂′ and one of R₃′ and R₄′ represents methyl; and the other ones of and R₂′ and of R₃′ and R₄′ represent ethyl;
R₅′ and R₆′ independently of one another represent hydrogen or methyl; and
R₇ represents phenyl, phenyl-C₁-C₄alkyl; (C₁-C₄alkyl)₁₋₃phenyl, or (C₁-C₄alkyl)₁₋₃phenyl-C₁-C₄alkyl.

The invention further relates to a composition which comprises
a) A compound (I), wherein R, R₁-R₆ and Z are as defined above; and
b) A polymer substrate; and
   to a process for imparting flame retardancy to the polymer substrate. The compositions that comprise the compounds (I) according to the invention exhibit excellent flame retardant properties. Dependent on the concentrations of components a) and b) in the polymer substrate, V-0 or V-2 ratings according to UL-94 (Underwriter's Laboratories Subject 94) and other excellent ratings in related test methods, e.g. according to DIN 4102 B2 are attained.

A preferred embodiment of the invention relates to a compound (I), wherein
R represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁₋₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁-R₄ represent methyl; or
One of R₁ and R₂ and one of R₃ and R₄ represents methyl; and the other ones of R₁ and
R₂ and of R₃ and R₄ represent ethyl;
R₅ and R₆ independently of one another represent hydrogen or methyl;
And Z represents a group of the partial formula:

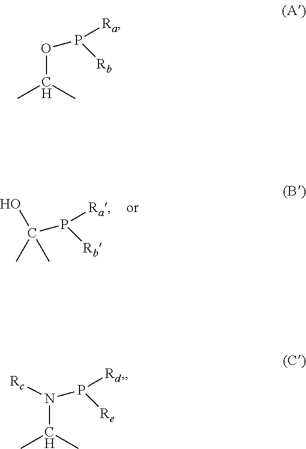

Wherein
Rₐ and Rₐ′ and R_{b} and R_{b}′ independently of one another represent
C₁-C₄alkyl, C₁-C₄alkoxy, phenyl or phenoxy;
R_{c} represents hydrogen or C₁-C₁₂alkyl; and
R_{d} and Rₑ independently of one another represent C₁-C₄alkoxy, phenyl or phenoxy or together represent C₂-C₈alkylenedioxy; or
Z represents a group of the partial formula

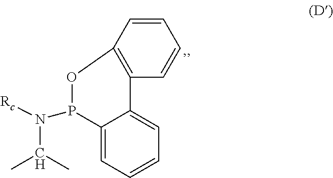

Wherein
R_{c} represents hydrogen or C₁-C₁₂alkyl; or
Z represents a group of the partial formula

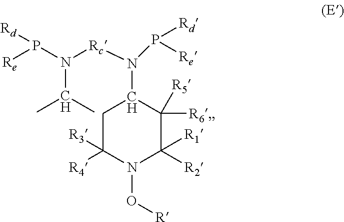

Wherein
R_{c}′ represents C₂-C₈alkylene;
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃ phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
One of R₁′ and R₂′ and one of R₃ and R₄′ represents methyl; and the other ones of R₁′ and
R₂′ and of R₃′ and R₄′ represent ethyl;
R₅′ and R₆′ independently of one another represent hydrogen or methyl; and
R_{d}′ and Rₑ′ independently of one another represent C₁-C₄alkoxy, phenyl or phenoxy; or
R_{d}′ and Rₑ′ together represent C₂-C₈alkylenedioxy.

A particularly preferred embodiment of the invention relates to a compound (I), wherein
R represents hydrogen or C₁-C₁₂alkyl;
R₁-R₄ represent methyl;
R₅ and R₆ represent hydrogen;
And Z is as defined above.

A highly preferred embodiment of the invention relates to a compound (I), wherein
R represents hydrogen or C₁-C₁₂alkyl;
R₁-R₄ represent methyl;
R₅ and R₆ represent hydrogen;
And Z represents a group of the partial formula (A), (B) or (C),
Wherein
Rₐ and Rₐ′ and R_{b} and R_{b}′ independently of one another represent
C₁-C₄alkoxy or phenyl;
R_{c} represents C₁-C₁₂alkyl; and
R_{d} and Rₐ independently of one another represent C₁-C₄alkoxy or phenyl; or
together represent C₂-C₈alkylenedioxy; or
Z represents a group of the partial formula (D),
Wherein
R_{c} represents C₁-C₁₂alkyl; or
Z represents a group of the partial formula (E),
Wherein
R_{c}′ represents C₂-C₈alkylene;
R′ represents C₁-C₁₂alkyl;
R₁′-R₄′ represent methyl;
R₅′ and R₆′ represent hydrogen; and
R_{d}′ and Rₑ′ independently of one another represent C₁-C₄alkoxy or phenyl; or
R_{d}′ and Rₑ′ together represent C₂-C₈alkylenedioxy; or
Z represents a group of the partial formula (F),
Wherein
R′ represents C₁-C₁₂alkyl;
R₁′-R₄′ represent methyl;
R₅′ and R₆′ represent methyl; and
R₇ represents phenyl.

An embodiment of the invention of first choice relates to a compound (I), wherein
R represents C₁-C₈alkyl;
R₁-R₄ represent methyl;
R₅ and R₆ represent hydrogen;
And Z represents a group of the partial formula (A), (B) or (C),
Wherein
Rₐ and Rₐ′ and R_{b} and R_{b}′ independently of one another represent
C₁-C₄alkoxy or phenyl;
R_{c} represents C₁-C₆alkyl; and
R_{d} and Rₑ independently of one another represent C₁-C₄alkoxy or phenyl; or
together represent C₂-C₈alkylenedioxy; or
Z represents a group of the partial formula (D),
Wherein
R_{c} represents C₁-C₈alkyl; or
Z represents a group of the partial formula (E),
Wherein
R_{c}′ represents C₂-C₈alkylene;
R′ represents C₁-C₁₂alkyl;
R₁′-R₄′ represent methyl;
R₅′ and R₆′ represent hydrogen; and
R_{d}′ and Rₑ′ independently of one another represent C₁-C₄alkoxy or phenyl; or
R_{d}′ and Rₑ′ together represent C₂-C₈alkylenedioxy; or
Z represents a group of the partial formula (F),
Wherein
R′ represents C₁-C₁₂alkyl;
R₁′-R₄′ represent methyl;
R₅′ and R₆′ represent methyl; and
R₇ represents phenyl.

Highly preferred are compounds (I) selected from the group consisting of

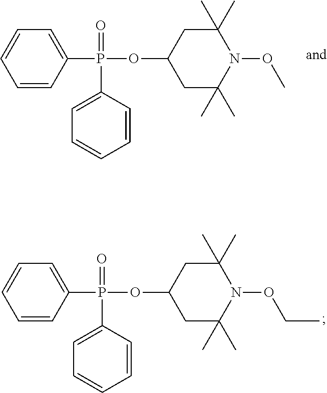 [SMILES: CON1C(C)(C)CC(OP(=O)(c2ccccc2)c2ccccc2)CC1(C)C ; CCON1C(C)(C)CC(OP(=O)(c2ccccc2)c2ccccc2)CC1(C)C]

Or, in the alternative, a compound (I) selected from the group consisting of

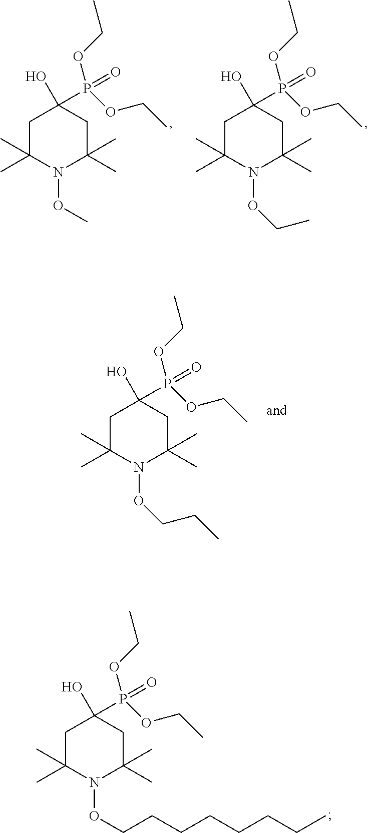

Or, in the alternative, a compound (I) according to claim 1 selected from the group consisting of

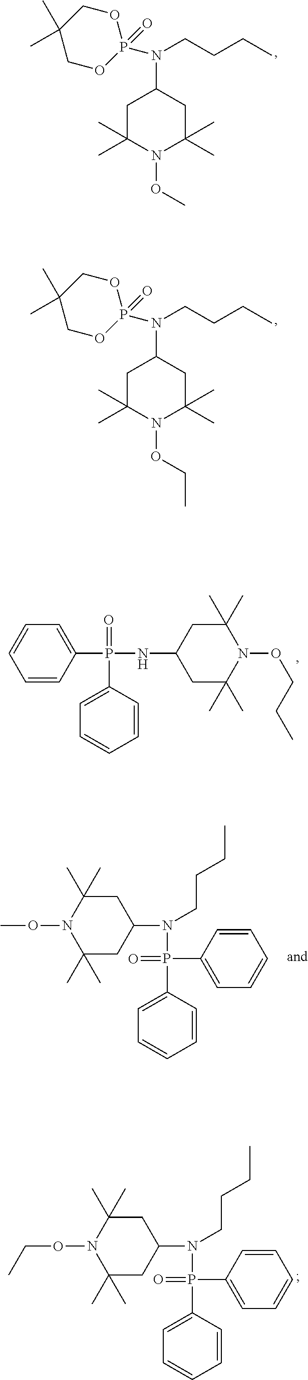

Or, in the alternative, the compound (I) of the formula

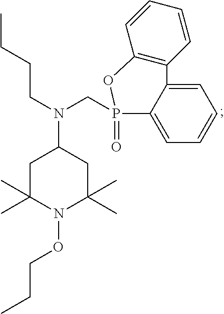 [SMILES: CCCCN(CP1(=O)Oc2ccccc2-c2ccccc21)C1CC(C)(C)N(OCCC)C(C)(C)C1]

Or, in the alternative, a compound (I) selected from the group consisting of

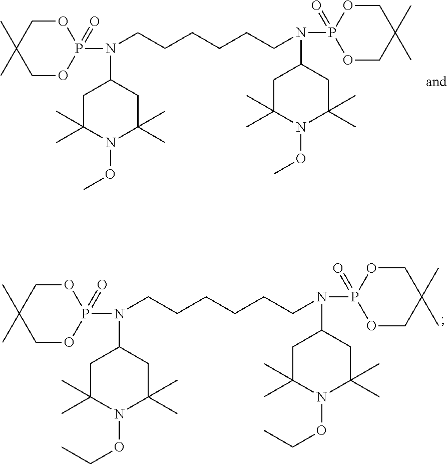

Or, in the alternative, a compound (I) selected from the group consisting of

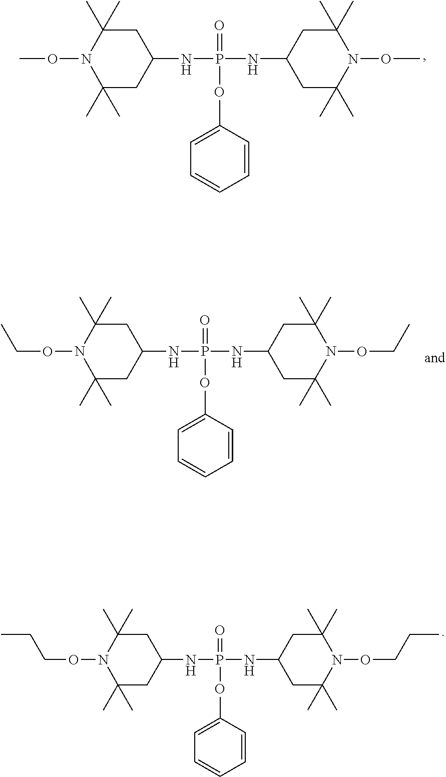

A further embodiment of the invention relates to the process for the preparation of the compounds (I) by conventional methods which are known by themselves, particularly the process for preparing the compounds (I) according to the preferred embodiments mentioned above, particularly the process for the preparation of the specific compounds mentioned above.

The terms and expressions used in the present description of the invention preferably have the following meanings:

R defined as C₁-C₁₂alkyl is methyl, ethyl, 1- or 2-propyl or straight chain or branched C₄-C₁₂alkyl, such as n-butyl, sec-butyl, tert-butyl, n-hexyl, n-octyl, 2-ethylhexyl, n-nonyl, n-decyl, n-undecyl or n-dodecyl.

Hydroxy-C₂-C₁₂alkyl is 2-hydroxyethyl or 2- or 3-hydroxypropyl or any of the above-mentioned C₄-C₁₂alkyl groups substituted in 2-position or, where possible, in any higher position by hydroxy.

Dihydroxy-C₃-C₁₂alkyl is, for example, 2,3-dihydroxypropyl or any of the above-mentioned C₄-C₁₂alkyl groups substituted in 2- and 3-positions by two hydroxy groups or where possible C₄-C₁₂alkyl group substituted in higher positions by two hydroxy groups.

Phenyl-C₁-C₄alkyl is, for example, benzyl or 1- or 2-phenylethyl.

(C₁-C₄Alkyl)₁₋₃phenyl is, for example, tolyl (o-, m- and p-), xylyl or mesityl.

(C₁-C₄Alkyl)₁₋₃phenyl-C₁-C₄alkyl is, for example, 2- or 6-methylbenzyl.

(C₁-C₄Alkoxy)₁₋₃phenyl is, for example, o-, m- or p-methoxy or ethoxyphenyl.

(C₁-C₄Alkoxy)₁₋₃phenyl-C₁-C₄alkyl is, for example, o-, m- or p-methoxy or ethoxybenzyl.

C₃-C₈Cycloalkyl is preferably cyclopentyl or cyclohexyl.

C₃-C₈Cycloalkyl-C₁-C₄alkyl is, for example cyclopentylmethyl or cyclohexylethyl or 1- or 2-cyclopentylethyl or 1- or 2-cyclohexylethyl.

—C(═O)—C₁-C₁₉Alkyl represents the acyl group of a C₁-C₂₀alkanoic acid, such as acetyl, pivaloyl, lauroyl (C12), myristoyl (C14), palmitoyl (C16) or stearoyl (C18).

In the embodiment wherein in a compound (I) Z represents a group of the partial formula

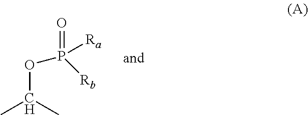

Rₐ and R_{b} independently of one another represent C₁-C₄alkyl, C₁-C₄alkoxy, phenyl or phenoxy, preferably C₁-C₄alkoxy or phenyl.

Representative compounds (I) are

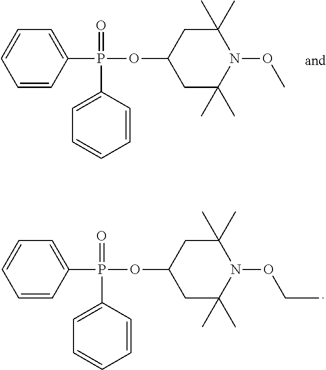 [SMILES: CON1C(C)(C)CC(OP(=O)(c2ccccc2)c2ccccc2)CC1(C)C ; CCON1C(C)(C)CC(OP(=O)(c2ccccc2)c2ccccc2)CC1(C)C]

In the embodiment wherein in a compound (I) Z represents a group of the partial formula

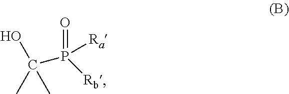

Rₐ′ and R_{b}′ independently of one another represent C₁-C₄alkyl, C₁-C₄alkoxy, phenyl or phenoxy, preferably C₁-C₄alkoxy or phenyl.

Representative compounds (I) are

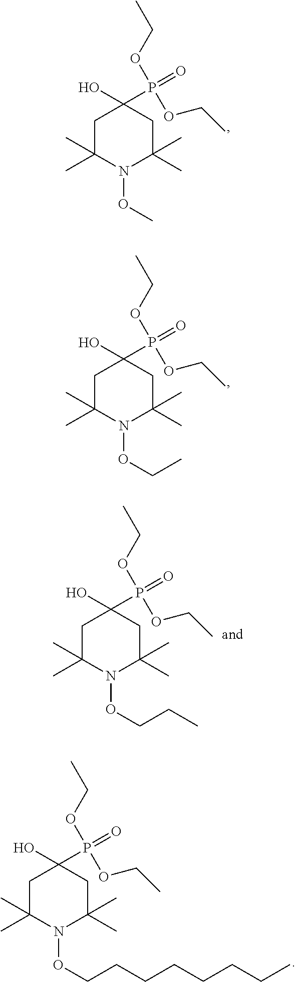

In the embodiment wherein in a compound (I) Z represents a group of the partial formula

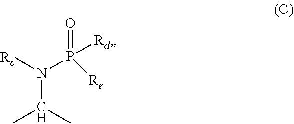

R_{c} represents hydrogen or C₁-C₁₂alkyl, particularly C₁-C₈alkyl; and

R_{d} and Rₑ independently of one another represent C₁-C₄alkoxy, particularly methoxy or ethoxy, phenyl or phenoxy; or together represent C₂-C₈alkylenedioxy, for example ethylenedioxy, 1,3-trimethylenedioxy or 2,2-dimethyl-1,3-propylenedioxy.

Representative compounds (I) are

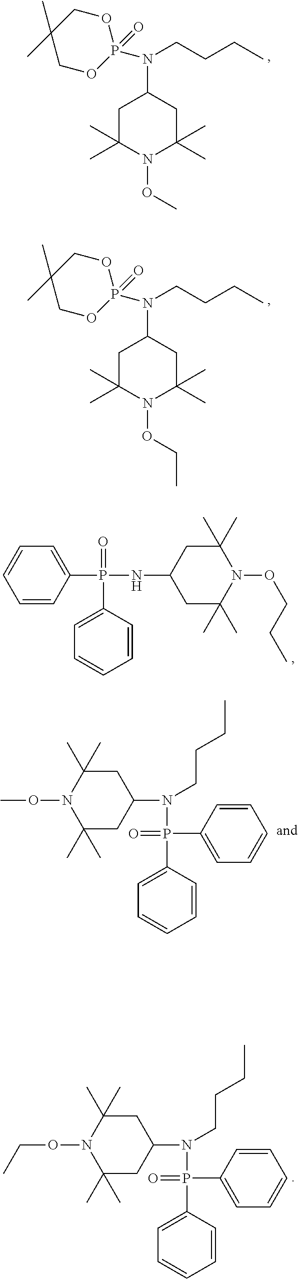

In the embodiment wherein in a compound (I) Z represents the group of the partial formula

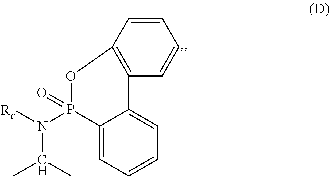

R_{c} represents hydrogen or C₁-C₁₂alkyl, particularly C₁-C₈alkyl.

A representative compound (I) is

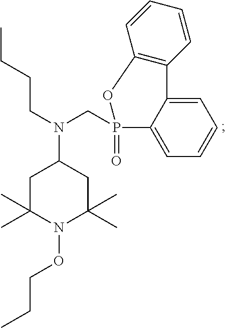 [SMILES: CCCCN(CP1(=O)Oc2ccccc2-c2ccccc21)C1CC(C)(C)N(OCCC)C(C)(C)C1]

In the embodiment wherein in a compound (I) Z represents a group of the partial formula

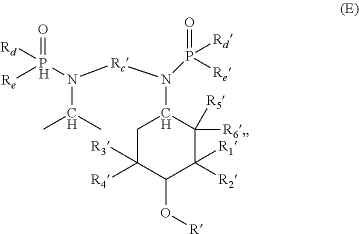

R_{c}′, R′, R₁′-R₄′, R₅′ and R₆′, R_{d}′ and Rₑ′ are as defined as R_{c}, R, R₁-R₄, R₅ and R₆ and R_{d} and Rₑ.

Representative compounds (I) are

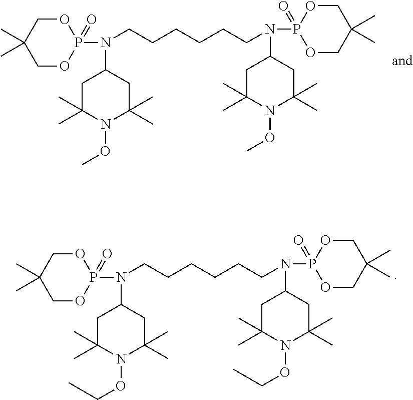

In the embodiment wherein in a compound (I) Z represents a group of the partial formula

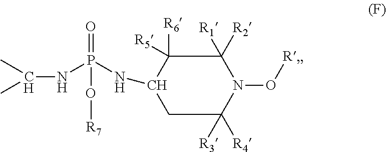

R′, R₁′-R₄′ and R₅′ and R₆′ are as defined as R, R₁-R₄ and R₅ and R₆. R₇ represents phenyl, phenyl-C₁-C₄alkyl; (C₁-C₄alkyl)₁₋₃phenyl, or (C₁-C₄alkyl)₁₋₃phenyl-C₁-C₄alkyl with the above-mentioned meanings.

Representative compounds (I) are

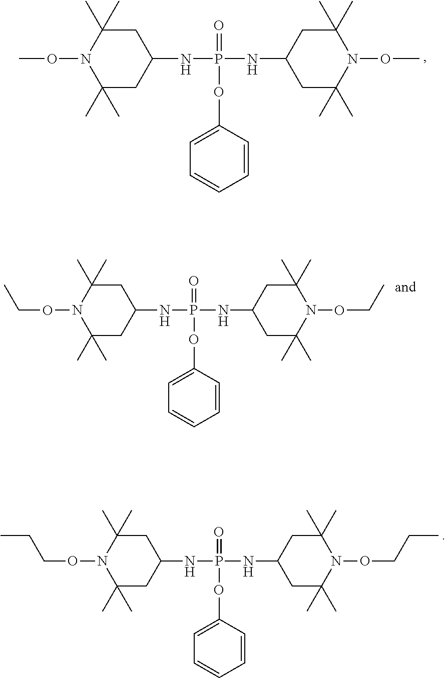

The compounds (I) are prepared by known methods as illustrated in the Examples.

The term polymer substrate comprises within its scope thermoplastic polymers or thermosets.

A non-exhaustive list of suitable thermoplastic polymers is given below:
1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cyclooleflns, for instance of cyclopentene or norbornene, polyethylene (which optionally can be cross linked), for example high density polymethylene (HDPE), high density and high molecular weight polyethylene (HDPE-HMW), high density and ultrahigh molecular weight polyethylene (HDPE-UHMW), medium density polyethylene (MOPE), low density polyethylene (LOPE), linear low density polyethylene (LLDPE), (VLDPE) and (ULDPE).
   Polyolefins, i.e. the polymers of monoolefins exemplified in the preceding paragraph, preferably polyethylene and polypropylene, can be prepared by different and especially by the following methods:
   a) Radical polymerisation (normally under high pressure and at elevated temperature).
   b) Catalytic polymerisation using a catalyst that normally contains one or more than one metal of groups IVb, Vb, Vlb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, and amine or silyl ether groups. These catalyst systems are usually termed Phillips, Standard Oil Indiana, Ziegler-Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EAA, LLDPE/EAA and alternating or random polyalkylene/carbon monoxide copolymers and mixtures thereof with other polymers, for example polyamides.
4. Hydrocarbon resins (for example C₅-C₉) including hydrogenated modifications thereof (e.g. tackifiers) and mixtures of polyalkylenes and starch;
   The homopolymers and copolymers mentioned above may have a stereo structure including syndiotactic, isotactic, hemi-isotactic or atactic; where atactic polymers are preferred. Stereo block polymers are also included.
5. Polystyrene, poly(p-methylstyrene), poly(α-methylstyrene).
6. Aromatic homopolymers and copolymers derived from vinyl aromatic monomers including styrene, α-methylstyrene, all isomers of vinyl toluene, especially p-vinyl toluene, all isomers of ethyl styrene, propyl styrene, vinyl biphenyl, vinyl naphthalene, and vinyl anthracene, and mixtures thereof. Homopolymers and copolymers may have a stereo structure including syndiotactic, isotactic, hemi-isotactic or atactic arrangement; where atactic polymers are preferred. Stereo block polymers are also included;
   a) Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.
   b) Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).
   c) Hydrogenated aromatic polymers derived from hydrogenation of polymers mentioned under 6a). Homopolymers and copolymers may have a stereo structure including syndiotactic, isotactic, hemi-isotactic or atactic arrangement; where atactic polymers are preferred. Stereo block polymers are also included.
7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.
8. Halogen-containing polymers such as polychloroprene, chlorinated rubbers, chlorinated and brominated copolymer of isobutylene-isoprene (halobutyl rubber), chlorinated or sulphochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.
9. Polymers derived from α,β-unsaturated acids and derivatives thereof such as polyacrylates and polymethacrylates; polymethyl methacrylates, polyacrylamides and polyacrylonitriles, impact-modified with butyl acrylate.
10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.
11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1 above.
12. Homopolymers and copolymers of cyclic ethers such as polyalkylene glycols, polyethylene oxide, polypropylene oxide or copolymers thereof with bisglycidyl ethers.
13. Polyacetals such as polyoxymethylene and those polyoxymethylenes, which contain ethylene oxide as a co-monomer; polyacetals modified with thermoplastic polyurethanes, acrylates or MBS.
14. Polyphenylene oxides and sulphides, and mixtures of polyphenylene oxides with styrene polymers or polyamides.
15. Polyurethanes derived from hydroxyl-terminated polyethers, polyesters or polybutadienes on the one hand and aliphatic or aromatic polyisocyanates on the other, as well as precursors thereof.
16. Polyamides and co-polyamides derived from diamines and dicarboxylic acids and/or from aminocarboxylic acids or the corresponding lactams, for example Polyamide 4, Polyamide 6, Polyamide 4/10, 5/10, 6/6, 6/10, 6/9, 6/12, 4/6, 12/12, Polyamide 11, Polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or co-polyamides modified with EPDM or ABS; and polyamides condensed during processing (RIM polyamide systems).
17. Polyureas, polyimides, polyamide imides, polyether imides, polyester imides, polyhydantoins and polybenzimidazoles.
18. Polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoates, as well as block co-polyether esters derived from hydroxylterminated polyethers; and also polyesters modified with polycarbonates or MBS.
19. Polyketones.
20. Polysulphones, polyether sulphones and polyether ketones.
21. Blends of the aforementioned polymers (polyblends), for example PP/EPDM, Polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.
22. Polycarbonates that correspond to the general formula:

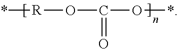

Such Polycarbonates are obtainable by interfacial processes or by melt processes (catalytic transesterification). The polycarbonate may be either branched or linear in structure and may include any functional substituents. Polycarbonate copolymers and polycarbonate blends are also within the scope of the invention. The term polycarbonate should be interpreted as inclusive of copolymers and blends with other thermoplastics. Methods for the manufacture of polycarbonates are known, for example, from U.S. Pat. Nos. 3,030,331; 3,169,121; 4,130,458; 4,263,201; 4,286,083; 4,552,704; 5,210,268; and 5,606,007. A combination of two or more polycarbonates of different molecular weights may be used.
Preferred are polycarbonates obtainable by reaction of a diphenol, such as bisphenol A, with a carbonate source. Examples of suitable diphenols are:

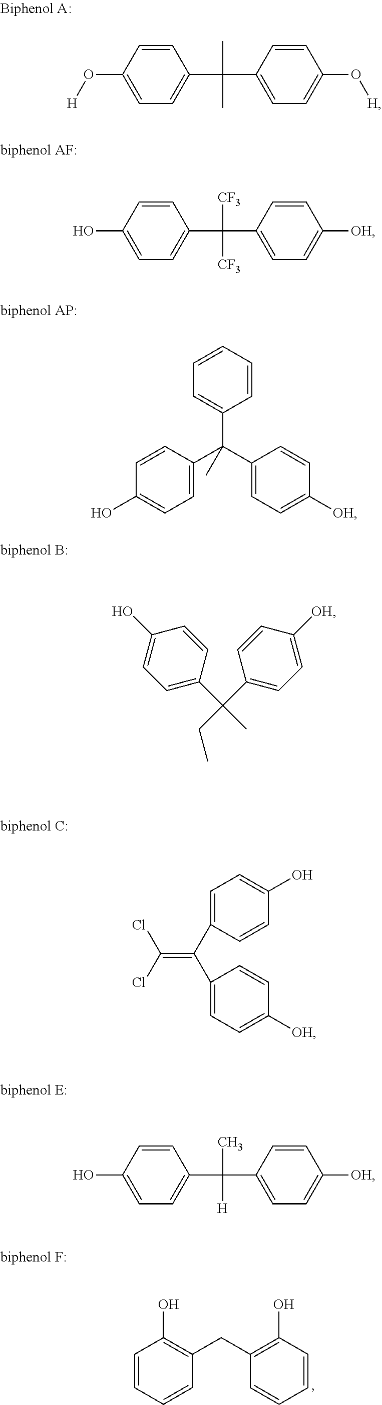

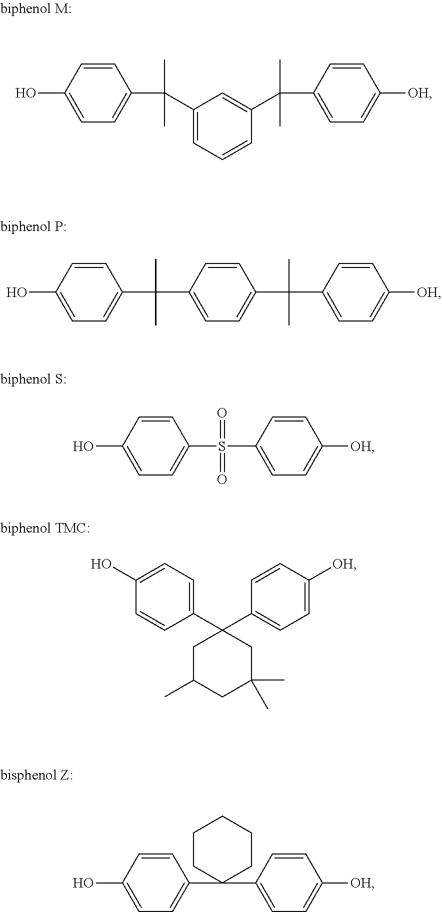 [SMILES: CC(C)(c1ccc(O)cc1)c1cccc(C(C)(C)c2ccc(O)cc2)c1 ; CC(C)(c1ccc(O)cc1)c1ccc(C(C)(C)c2ccc(O)cc2)cc1 ; O=S(=O)(c1ccc(O)cc1)c1ccc(O)cc1 ; CC1CC(C)(C)CC(c2ccc(O)cc2)(c2ccc(O)cc2)C1 ; Oc1ccc(C2(c3ccc(O)cc3)CCCCC2)cc1]

4,4′-(2-norbornylidene)bis(2,6-dichlorophenol); or fluorene-9-bisphenol:

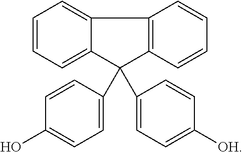 [SMILES: Oc1ccc(C2(c3ccc(O)cc3)c3ccccc3-c3ccccc32)cc1]

The carbonate source may be a carbonyl halide, a carbonate ester or a haloformate. Suitable carbonate halides are phosgene or carbonylbromide. Suitable carbonate esters are dialkylcarbonates, such as dimethyl- or diethylcarbonate, diphenyl carbonate, phenylalkylphenylcarbonate, such as phenyl-tolylcarbonate, dialkylcarbonates, such as dimethyl- or diethylcarbonate, di-(halophenyl)carbonates, such as di-(chlorophenyl)carbonate, di-(bromophenyl)carbonate, di-(trichlorophenyl)carbonate or di-(trichlorophenyl)carbonate, di-(alkylphenyl)carbonates, such as di-tolylcarbonate, naphthylcarbonate, dichloronaphthylcarbonate and others.

The polymer substrate mentioned above, which comprises polycarbonates or polycarbonate blends is a polycarbonate-copolymer, wherein isophthalate/terephthalate-resorcinol segments are present. Such polycarbonates are commercially available, e.g. Lexan® SLX (General Electrics Co. USA). Other polymeric substrates of component b) may additionally contain in the form as admixtures or as copolymers a wide variety of synthetic polymers including polyolefins, polystyrenes, polyesters, polyethers, polyamides, poly(meth)acrylates, thermoplastic polyurethanes, polysuiphones, polyacetals and PVC, including suitable compatibilizing agents. For example, the polymer substrate may additionally contain thermoplastic polymers selected from the group of resins consisting of polyolefins, thermoplastic polyurethanes, styrene polymers and copolymers thereof. Specific embodiments include polypropylene (PP), polyethylene (PE), polyamide (PA), polybutylene terephthalate (PBT), polyethylene terephthalate (PET), glycol-modified polycyclohexylenemethylene terephthalate (PCTG), polysulphone (PSU), polymethylmethacrylate (PMMA), thermoplastic polyurethane (TPU), acrylonitrile-butadiene-styrene (ABS), acrylonitrile-styrene-acrylic ester (ASA), acrylonitrile-ethylene-propylene-styrene (AES), styrene-maleic anhydride (SMA) or high impact polystyrene (HIPS).
23. Epoxy resins consisting of a di- or polyfunctional epoxide compound, wherein at least two epoxy groups of the partial formula

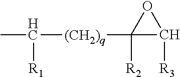

are present, which are attached directly to carbon, oxygen, nitrogen or sulphur atoms, and wherein q represents zero, R₁ and R₃ both represent hydrogen and R₂ represents hydrogen or methyl; or wherein q represents zero or 1, R₁ and R₃ together form the —CH₂—CH₂— or —CH₂—CH₂—CH₂— groups and R₂ represents hydrogen.
Suitable hardener components are, for example, amine and anhydride hardeners such as polyamines, e.g. ethylenediamine, diethylenetriamine, triethylenetriamine, hexamethylenediamine, methanediamine, N-aminoethyl piperazine, diaminodiphenylmethane [DDM], alkyl-substituted derivatives of DDM, isophoronediamine [IPD], diaminodiphenylsulphone [DDS], 4,4′-methylenedianiline [MDA], or m-phenylenediamine [MPDA]), polyamides, alkyl/alkenyl imidazoles, dicyandiamide [DICY], 1,6-hexamethylene-bis-cyanoguanidine, or acid anhydrides, e.g. dodecenylsuccinic acid anhydride, hexahydrophthalic acid anhydride, tetrahydrophthalic acid anhydride, phthalic acid anhydride, pyromellitic acid anhydride, and derivatives thereof.

A preferred embodiment of the invention relates to compositions which comprise as component c) thermoplastic polymers. Preferred thermoplastic polymers include polyolefin homo- and copolymers, in particular polypropylene, copolymers of olefins vinyl monomers, styrenic homopolymers and copolymers thereof.

In the event that the inventive alkoxyamines are solid or melt at a higher temperature than the processing temperature of the polymer, it can be advantageous that these are ground to a fine powder with an average particle size below 100 μm prior to their application in polymer substrates, as it is observed that the flame retardant properties of the inventive compositions are improved by small particle sizes.

The instant invention further pertains to a composition, which comprises, in addition to the components a) and b), as defined above, as optional components, additional flame retardants and further additives selected from the group consisting of so-called anti-dripping agents and polymer stabilizers.

Representative phosphorus containing flame retardants are for example:

Tetraphenyl resorcinol diphosphate (Fyrolflex® RDP, Akzo Nobel), resorcinol diphosphate oligomer (RDP), triphenyl phosphate, tris(2,4-di-tert-butylphenyl)phosphate, ethylenediamine diphosphate (EDAP), ammonium polyphosphate, diethyl-N,N-bis(2-hydroxyethyl)-aminomethyl phosphonate, hydroxyalkyl esters of phosphorus acids, salts of di-C₁-C₄alkylphosphinic acids and of hypophosphoric acid (H₃PO₂), particularly the Ca²⁺, Zn²⁺, or Al³⁺ salts, tetrakis(hydroxymethyl)phosphonium sulphide, triphenylphosphine, derivatives of 9,10-dihydro-9-oxa-10-phosphorylphenanthrene-10-oxide (DOPO), phosphazene flame-retardants and polycarbonates based on methanephosphonic acid.

Nitrogen containing flame retardants are, for example, isocyanurate flame retardants, such as polyisocyanurate, esters of isocyanuric acid or isocyanurates. Representative examples are hydroxyalkyl isocyanurates, such as tris-(2-hydroxyethyl)isocyanurate, tris(hydroxymethyl)-isocyanurate, tris(3-hydroxy-n-proyl)isocyanurate or triglycidyl isocyanurate.

Nitrogen containing flame-retardants include further melamine-based flame-retardants. Representative examples are: melamine cyanurate, melamine borate, melamine phosphate, melamine pyrophosphate, melamine polyphosphate, melamine ammonium polyphosphate, melamine ammonium pyrophosphate, dimelamine phosphate and dimelamine pyrophosphate.

Further examples are: benzoguanamine, pyrimidines, such as 6-aminouracil tris(hydroxyethyl)-isocyanurate, allantoin, glycoluril, urea cyanurate, ammonium polyphosphate, a condensation product of melamine from the series melem, melam, melon and/or a higher condensed compound or a reaction product of melamine with phosphoric acid or a mixture thereof.

Representative organohalogen flame retardants are, for example:

Polybrominated diphenyl oxide (DE-60F, Great Lakes Corp.), decabromodiphenyl oxide (DBDPO; Saytex® 102E), tris[3-bromo-2,2-bis(bromomethyl)propyl]phosphate (PB 370®, FMC Corp.), tris(2,3-dibromopropyl)phosphate, tris(2,3-dichloropropyl)phosphate, chlorendic acid, tetrachlorophthalic acid, tetrabromophthalic acid, poly-β-chloroethyl triphosphonate mixture, tetrabromobisphenol A bis(2,3-dibromopropyl ether) (PE68), brominated epoxy resin, ethylenebis(tetrabromophthalimide) (Saytex® BT-93), bis(hexachlorocyclopentadieno)cyclooctane (Declorane Plus®), chlorinated paraffins, octabromodiphenyl ether, hexachlorocyclopentadiene derivatives, 1,2-bis(tribromophenoxy)ethane (FF680), tetrabromo-bisphenol A (Saytex® RB100), ethylene bis-(dibromo-norbornanedicarboximide) (Saytex®BN-451), bis-(hexachlorocycloentadeno)cyclooctane, PTFE, tris-(2,3-dibromopropyl)-isocyanurate, and ethylene-bis-tetrabromophthalimide.

The organohalogen flame retardants mentioned above are routinely combined with an inorganic oxide synergist. Most common for this use are zinc or antimony oxides, e.g. Sb₂O₃ or Sb₂O₅. Boron compounds are suitable, too.

Representative inorganic flame retardants include, for example, aluminum trihydroxide (ATH), boehmite (AlOOH), magnesium dihydroxide (MDH), zinc borates, CaCO₃, (organically modified) layered silicates, preferred in nano-sized form, (organically modified) layered double hydroxides, and mixtures thereof. The inorganic flame retardants such as ATH or MDH may be surface treated to improve their dispersion in the polymer matrix.

The above-mentioned additional flame retardant classes are advantageously contained in the composition of the invention in an amount from about 0.5% to about 60.0% by weight of the organic polymer substrate; for instance about 1.0% to about 40.0%; for example about 5.0% to about 35.0% by weight of the polymer or based on the total weight of the composition.

According to another embodiment, the invention relates to a composition which additionally comprises as additional component so-called anti-dripping agents.

These anti-dripping agents reduce the melt flow of the thermoplastic polymer and inhibit the formation of drops at high temperatures. Various references, such as U.S. Pat. No. 4,263,201, describe the addition of anti-dripping agents to flame retardant compositions.

Suitable additives that inhibit the formation of drops at high temperatures include glass fibers, polytetrafluoroethylene (PTFE), high temperature elastomers, carbon fibers, glass spheres and the like.

The addition of polysiloxanes of different structures has been proposed in various references; cf. U.S. Pat. Nos. 6,660,787, 6,727,302 or 6,730,720.

Stabilizers are preferably halogen-free and selected from the group consisting of nitroxyl stabilizers, nitrone stabilizers, amine oxide stabilizers, benzofuranone stabilizers, phosphite and phosphonite stabilizers, quinone methide stabilizers and monoacrylate esters of 2,2′-alkylidenebisphenol stabilizers.

As mentioned above, the composition according to the invention may additionally contain one or more conventional additives, for example selected from pigments, dyes, plasticizers, antioxidants, thixotropic agents, dispersing agents, levelling assistants, basic co-stabilizers, metal passivators, metal oxides, organophosphorus compounds, further light stabilizers and mixtures thereof, especially pigments, phenolic antioxidants, calcium stearate, zinc stearate, dispersing agents, UV absorbers of the 2-hydroxy-benzophenone, 2-(2′-hydroxyphenyl)benzotriazole and/or 2-(2-hydroxyphenyl)-1,3,5-triazine groups.

Preferred additional additives for the compositions as defined above are processing stabilizers, such as the above-mentioned phosphites and phenolic antioxidants, and light stabilizers, such as benzotriazoles. Preferred specific antioxidants include octadecyl 3-(3,5-di-tert-butyl-4-hydroxyphenyl)propionate (IRGANOX 1076), pentaerythritol-tetrakis[3-(3,5-di-tert-butyl-4-hydroxyphenyl)propionate] (IRGANOX 1010), tris(3,5-di-tert-butyl-4-hydroxyphenyl)isocyanurate (IRGANOX 3114), 1,3,5-trimethyl-2,4,6-tris(3,5-di-tert-butyl-4-hydroxybenzyl)benzene (IRGANOX 1330), triethyleneglycol-bis[3-(3-tert-butyl-4-hydroxy-5-methylphenyl)propionate] (IRGANOX 245), and N,N′-hexane-1,6-diyl-bis[3-(3,5-di-tert-butyl-4-hydroxyphenyl)propionamide] (IRGANOX 1098). Specific processing stabilizers include tris(2,4-di-tert-butylphenyl)phosphite (IRGAFOS 168), 3,9-bis(2,4-di-tert-butylphenoxy)-2,4,8,10-tetraoxa-3,9-diphosphaspiro[5.5]undecane (IRGAFOS 126), 2,2′,2″-nitrilo[triethyl-tris(3,3′,5,5′-tetra-tert-butyl-1,1′-biphenyl-2,2′-diyl)]phosphite (IRGAFOS 12), and tetrakis(2,4-di-tert-butylphenyl)[1,1-b]phenyl]-4,4′-diylbisphosphonite (IRGAFOS P-EPQ). Specific light stabilizers include 2-(2H-benzotriazole-2-yl)-4,6-bis(1-methyl-1-phenylethyl)phenol (TINUVIN 234), 2-(5-chloro(2H)-benzotriazole-2-yl)-4-(methyl)-6-(tert-butyl)phenol (TINUVIN 326), 2-(2H-benzotriazole-2-yl)-4-(1,1,3,3-tetramethylbutyl)phenol (TINUVIN 329), 2-(2H-benzotriazole-2-yl)-4-(tert-butyl)-6-(sec-butyl)phenol (TINUVIN 350), 2,2′-methylenebis(6-(2H-benzotriazol-2-yl)-4-(1,1,3,3-tetramethylbutyl)phenol) (TINUVIN 360), and 2-(4,6-diphenyl-1,3,5-triazin-2-yl)-5-[(hexyl)oxy]-phenol (TINUVIN 1577), 2-(2′-hydroxy-5′-methylphenyl)benzotriazole (TINUVIN P), 2-hydroxy-4-(octyloxy)benzophenone (CHIMASSORB 81), 1,3-bis-[(2′-cyano-3′,3′-diphenylacryloyl)oxy]-2,2-bis-{[(2′-cyano-3′,3′-diphenylacryloyl)oxy]methyl}-propane (UVINUL 3030, BASF), ethyl-2-cyano-3,3-diphenylacrylate (UVINUL 3035, BASF), and (2-ethylhexyl)-2-cyano-3,3-diphenylacrylate (UVINUL 3039, BASF).

Further preferred additives are from the class of dispersing agents. A suitable polymeric dispersing agent consists of a polymeric chain and at least one so-called anchoring group. The polymeric chain provides solubility properties within the polymeric substrate as well as steric stabilization and determines the compatibility with the polymer system, whereas the anchoring group is connected with the flame retardant molecule itself.

Suitable polymeric dispersing agents are characterized by their effect of wetting solid flame retardant molecules, prevent viscosity build-up by dispersed flame retardant particles and prevent such particles from reflocculation.

Suitable polymeric dispersing agents are based e.g. on styrene-maleic acid anhydride copolymers or on polyethers substituted by acidic groups.

The additives mentioned above are preferably contained in an amount of 0.01 to 10.0%, especially 0.05 to 5.0%, relative to the weight of the polymer substrate of Component b).

The incorporation of the components defined above into the polymer component is carried out by known methods such as dry blending in the form of a powder, or wet mixing in the form of solutions, dispersions or suspensions for example in an inert solvent, water or oil. The additive components a) and b) and optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers, etc.), e.g. as a dry mixture or powder, or as a solution or dispersion or suspension or melt.

The addition of the additive components to the polymer substrate can be carried out in customary mixing machines in which the polymer is melted and mixed with the additives. Suitable machines are known to those skilled in the art. They are predominantly mixers, kneaders and extruders.

The process is preferably carried out in an extruder by introducing the additive during processing.

Particularly preferred processing machines are single-screw extruders, contra-rotating and co-rotating twin-screw extruders, planetary-gear extruders, ring extruders or co-kneaders. Processing machines provided with at least one gas removal compartment can be used to which a vacuum can be applied.

Suitable extruders and kneaders are described, for example, in Handbuch der Kunststoffextrusion, Vol. 1 Grundlagen, Editors F. Hensen, W. Knappe, H. Potente, 1989, pp. 3-7, ISBN:3-446-14339-4 (Vol. 2 Extrusionsanlagen 1986, ISBN 3-446-14329-7).

For example, the screw length is 1-60 screw diameters, preferably 35-48 screw diameters. The rotational speed of the screw is preferably 10-600 rotations per minute (rpm), preferably 25-300 rpm.

The maximum throughput is dependent on the screw diameter, the rotational speed and the driving force. The process of the present invention can also be carried out at a level lower than maximum throughput by varying the parameters mentioned or employing weighing machines delivering dosage amounts.

If a plurality of components is added, these can be premixed or added individually.

The additive components a) and optional further additives can also be sprayed onto the polymer substrate b). The additive mixture dilutes other additives, for example the conventional additives indicated above, or their melts so that they can be sprayed also together with these additives onto the polymer substrate.

The additive components a) and b) optional further additives can also be added to the polymer in the form of a master batch (“concentrate”) which contains the components in a concentration of, for example, about 1.0% to about 60.0% and preferably 2.0% to about 30.0% by weight incorporated in a polymer. The polymer is not necessarily of identical structure than the polymer where the additives are added finally. In such operations, the polymer can be used in the form of powder, granules, solutions, and suspensions or in the form of lattices.

Incorporation can take place prior to or during the shaping operation. The materials containing the additives of the invention described herein preferably are used for the production of molded articles, for example roto-molded articles, injection molded articles, profiles and the like, and especially a fibre, spun melt non-woven, film or foam.

A further embodiment of the invention relates to a compound (I), wherein the phosphorus atom is in a lower oxidation state. Within the definition of such compounds (I)
R represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃Phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁-R₄ represent methyl; or
One of R₁ and R₂ and one of R₃ and R₄ represents methyl; and the other ones of R₁ and
R₂ and of R₃ and R₄ represent ethyl;
R₅ and R₆ independently of one another represent hydrogen or methyl;
And Z represents a group of the partial formula:

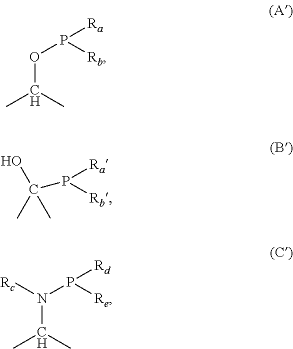

Wherein
Rₐ and Rₐ′ and R_{b} and R_{b}′ independently of one another represent
C₁-C₄alkyl, C₁-C₄alkoxy, phenyl or phenoxy;
R₁ represents hydrogen or C₁-C₁₂alkyl; and
R_{d} and Rₑ independently of one another represent C₁-C₄alkoxy, phenyl or phenoxy or together represent C₂-C₈alkylenedioxy; or
Z represents a group of the partial formula

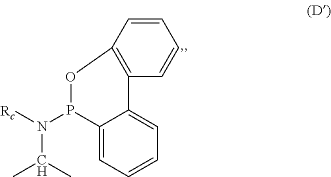

Wherein
R_{c} represents hydrogen or C₁-C₁₂alkyl; or
Z represents a group of the partial formula

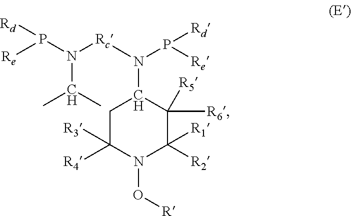

Wherein
Rₑ′ represents C₂-C₈alkylene;
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
One of R₁′ and R₂′ and one of R₃′ and R₄′ represents methyl; and the other ones of R₁′ and
R₂ and of R₃′ and R₄′ represent ethyl;
R₅′ and R₆′ independently of one another represent hydrogen or methyl; and
R_{d}′ and Rₑ′ independently of one another represent C₁-C₄alkoxy, phenyl or phenoxy; or
R_{d}′ and Rₑ′ together represent C₂-C₈alkylenedioxy.

These compounds are useful as intermediates for the preparation of compounds (I), wherein Z represents a group of the partial formula (A), (B), (C), (D), and (E). The conversion of these intermediates is performed by analogous methods which are known by themselves, for example by reaction with oxidizing agents, such as H₂O₂. The process is illustrated in the Examples below.

The following Examples illustrate the invention:

A) Synthesis of Representative Compounds

### EXAMPLE 1

### 1.1

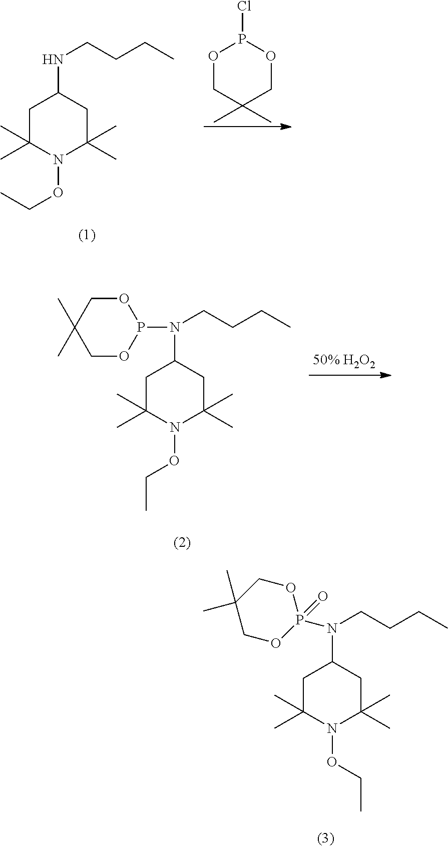

In a 250 ml sulphonation flask 8.67 g (1), 4.22 g triethylamine and 0.10 g 4-dimethylaminopyridine (DMAP) catalyst are dissolved in 50 ml toluene under nitrogen atmosphere. The reaction mixture is cooled to 0° C. A solution of 5.91 g 2-chloro-5,5-dimethyl-1,3,2-dioxaphosphorinane (commercially available from Aldrich) in 25 ml toluene is added, and the reaction temperature is maintained at 0°-5° C. for 45 min. After completion of the addition, the reaction mixture is stirred at room temperature for 16 h and filtered. The filtrate is washed with 100 ml water and 100 ml aqueous NaHCO₃-solution. The organic layer is washed 2× with 100 ml water. The organic layer is dried over sodium sulphate, and the solvent is removed under vacuum which yields 11.91 g of a viscous yellow liquid (2), which is dissolved in 30 ml dichloromethane under nitrogen atmosphere and cooled to 0° C. 2.50 g hydrogen peroxide (50%) are added slowly. The reaction mixture is stirred overnight. Any excess of hydrogen peroxide is decomposed by the addition of 20% of aqueous sodium metabisulphite solution. The organic layer is washed with 100 ml water and dried over sodium sulphate. 9.41 g of orange solid (3) are obtained after removing the solvent under vacuum (m.p.: 120-123° C.).

¹H-NMR (300 MHz, CDCl₃): δ 4.3 (2H), 3.6-3.8 (4H), 2.7-2.9 (3H), 1.79 (2H), 1.5-1.3 (4H), 1.25 (6H), 1.2 (12H), 0.6-0.9 (6H);

IR (neat): vₘₐₓ 2968, 2940, 1467, 1360, 1210, 1051, 1035, 1005, 960, 821 [cm⁻¹];

MS (m/z): 405.2 [M⁺H]⁺.

### 1.2

171.19 g of the starting material (1) is prepared from 150.0 g 1-ethoxy-4-oxo-2,2,6,6-tetramethylpiperidine (obtainable according to WO 2008/003602) in a manner analogous to Example 2.2.

### EXAMPLE 2

### 2.1

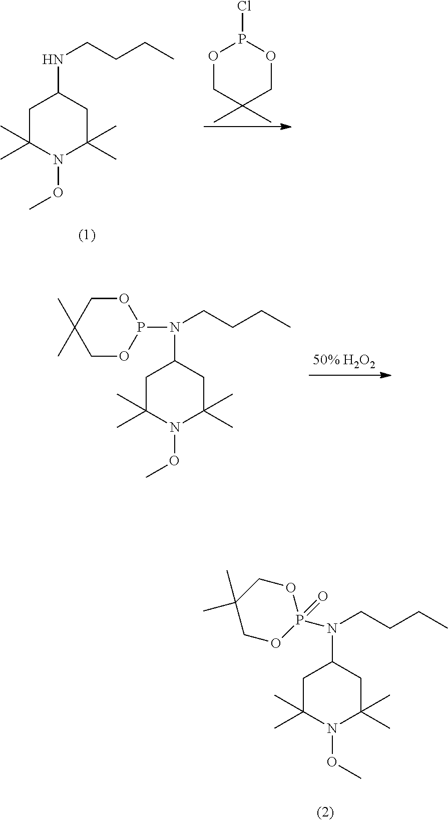

In a manner analogous to Example 1, 10.06 g (2) are prepared from 8.09 g (1).

¹H-NMR (300 MHz, CDCl₃): δ 3.9-3.6 (4H), 3.6 (3H), 2.9-3.1 (3H), 1.79 (2H), 1.6-1.3 (4H), 1.25 (8H), 1.2 (9H), 0.9 (3H), 0.7 (3H);

IR (neat): vₘₐₓ 2954, 2870, 1468, 1360, 1209, 1173, 1050, 999, 742 [cm⁻¹];

MS (m/z): 391 [M⁺H]⁺.

### 2.2

The starting material (1) is prepared as follows:

A 2000 ml steel autoclave is charged with 150.0 g of 1-methoxy-4-oxo-2,2,6,6-tetramethylpiperidine (obtainable according to WO 2008/003602) together with 100 ml methanol under nitrogen atmosphere. 65.1 g n-butylamine are added to the same reactor together with 0.5 g 10% Pd on carbon. The reaction mixture is stirred at 100° C. by applying hydrogen pressure of 8-10 kg for 20-24 h. The reaction is monitored by ¹³C-NMR-spectroscopy. After disappearance of the >C═O group in the ¹³C-NMR spectrum, the reaction mixture is cooled to room temperature. The catalyst is removed by filtering the reaction mixture through a Hyflo® bed. 178.08 g (yield 95%) of product are obtained as an orange brown liquid after removing the solvent under vacuum. The product is used without further purification product in the next step (21). MS (m/z): 243 [M⁺]⁺.

### EXAMPLE 3

### 3.1

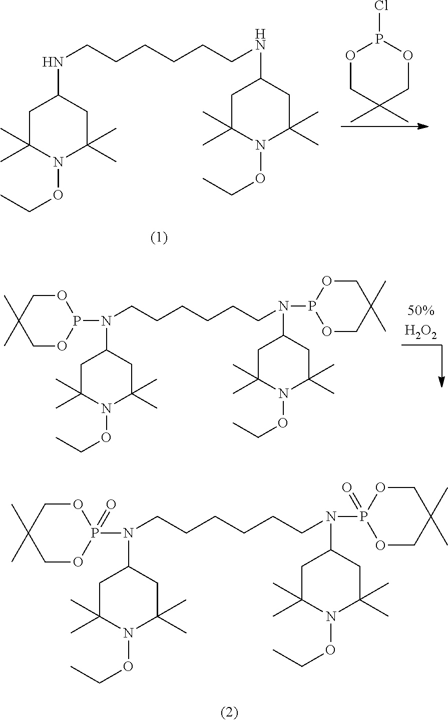

In a manner analogous to Example 1, 5.4 g (2) are prepared from 8.6 g (1) and obtained as a yellowish solid.

¹H-NMR (300 MHz, CDCl₃): δ 4.3 (4H), 3.6-3.8 (8H), 2.9-3.1 (6H), 2.6 (H), 1.79 (4H), 1.5-1.3 (14H), 1.25 (15H), 1.24 (15H), 0.7-0.9 (6H);

IR (neat): vₘₐₓ 3415, 2973, 1472, 1362, 1210, 1056, 1041, 1006, 948, 814 [cm⁻¹];

MS (m/z): 779.86 [M⁺H]⁺.

### 3.2

The starting material is prepared as follows:

165.1 g of the starting material (1) is prepared from 165.1 g 1-ethoxy-4-oxo-2,2,6,6-tetramethylpiperidine and 40.82 g 1,6-diaminohexane in a manner analogous to Example 2.2.

MS (m/z): 483 [M⁺H]⁺.

### EXAMPLE 4

### 4.1

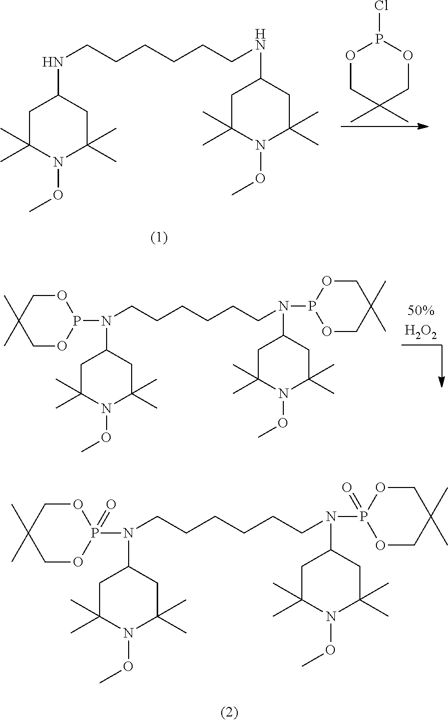

In a manner analogous to Example 1, 5.6 g (2) are prepared from 7.5 g (1) and obtained as a white solid.

¹H-NMR (300 MHz, CDCl₃): δ 4.3 (4H), 3.7-3.9 (4H), 3.5 (6H), 3.0 (6H), 1.79 (4H), 1.5-1.3 (14H), 1.25 (15H), 1.24 (15H), 0.7-0.9 (6H);

IR (neat): vₘₐₓ 3429, 2967, 1469, 1361, 1212, 1052, 1034, 1003, 81 [cm⁻¹];

MS (m/z): 751 [M⁺H]⁺.

### 4.2

The starting material is prepared as follows:

172.84 g of the starting material (1) is prepared from 150.0 g 1-methoxy-4-oxo-2,2,6,6-tetramethylpiperidine in a manner analogous to Example 2.2. MS (m/z): 455 [M^{+H]}⁺.

### EXAMPLE 5

### 5.1

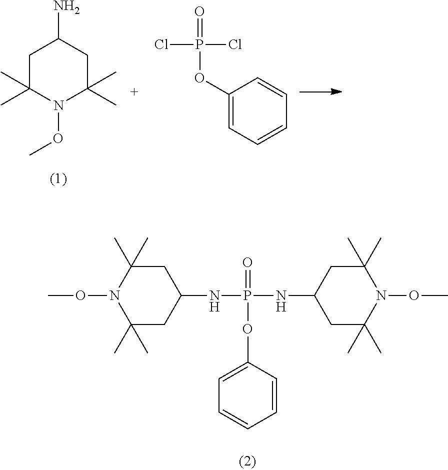

In a 100 ml sulphonation flask 106.0 g (1) are dissolved in 50 ml dichloromethane under nitrogen atmosphere and cooled to 0° C. A solution of 3.0 g phenyldichlorophosphate in 10 ml dichloromethane is added, and the temperature is maintained at 0°-5° C. for 60 min. After completion of the addition, the reaction mixture is stirred at 0°-5° C. for 1 h and for 12 h at room temperature. The progress of the reaction is monitored by TLC. 50 ml of water is added to the reaction mixture and the layers are separated. The organic layer is washed thoroughly with water and dried over sodium sulphate. 4.76 g of an orange resin like product are obtained after removing the solvent under vacuum. The Product is purified by column chromatography with ethyl acetate/methanol (9.5:0.5) as the mobile phase. 2.57 g of crème-coloured solid compound are obtained.

¹H-NMR (300 MHz, CDCl₃): δ 7.2-7.4 (5H), 3.61 (6H), 2.6 (2H), 1.8-1.0 (32H);

IR (neat): vₘₐₓ 3202, 2974, 2930, 1593, 1491, 1452, 1360, 1198, 1036, 918, 761 [cm⁻¹);

MS (m/z): 511 [M⁺H]⁺.

### 5.2

The starting material (1) is prepared from 1-methoxy-4-oxo-2,2,6,6-tetramethylpiperidine in a manner analogous to Example 7.2 and obtained as a brownish liquid. MS (Cl): 187 (MH+).

### EXAMPLE 6

### 6.1

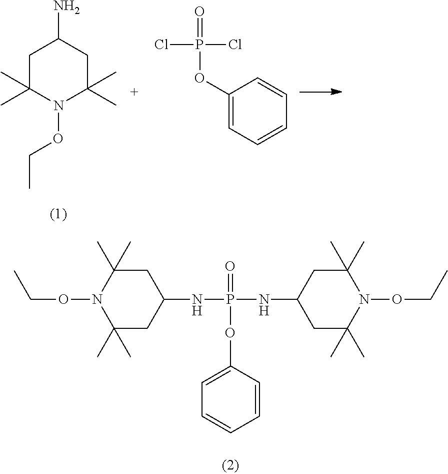

In a manner analogous to Example 5, 5.6 g (2) are prepared from 7.5 g (1) and obtained as a white solid.

¹H-NMR (300 MHz, CDCl₃): δ 7.2-7.4 (5H), 3.7 (4H), 2.6 (2H), 1.8-1.0 (38H);

IR (neat): vₘₐₓ 3155, 2973, 2930, 1492, 1454, 1199, 1039, 920, 762 [cm⁻¹];

MS (m/z): 539.3 [M⁺H]⁺.

### 6.2

The starting material (1) is prepared from 1-ethoxy-4-oxo-2,2,6,6-tetramethylpiperidine in a manner analogous to Example 7.2 and obtained as a brownish liquid.

MS (Cl): 201 (MH+).

### EXAMPLE 7

### 7.1

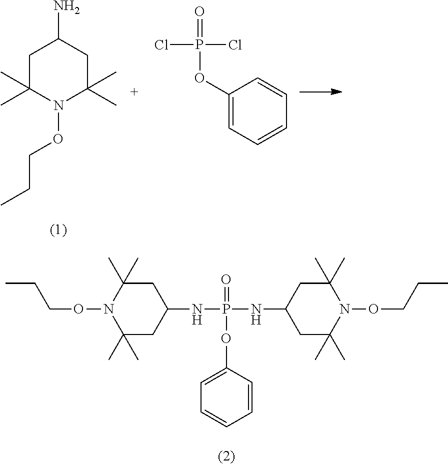

In a manner analogous to Example 5, 6.2 g (2) are prepared from 12.19 g (1) and phenyldichlorophosphate and obtained as a white solid.

¹H-NMR (300 MHz, CDCl₃): δ 7.2-7.4 (5H), 3.7 (2H), 3.3 (H), 2.6 (2H), 1.79 (2H), 1.5-1.3 (2H), 1.25 (6H), 1.2 (6H), 0.9 (3H);

IR (neat): vₘₐₓ 3268, 3151, 2971, 2935, 1488, 1457, 1199, 1095, 920, 760 [cm⁻¹];

MS (m/z): 567.4 [M⁺H]⁺.

### 7.2

The starting material (1) is prepared as follows:

50.0 g (0.234 mol) 1-propoxy-2,2,6,6-tetramethyl-piperidin-4-one are hydrogenated with 5.0 g Raney-Cobalt catalyst in 500 ml methanol for 2 h at 100° C./10.0 bar in the presence of 250 ml of methanolic ammonia solution (0.2 g/ml). After filtration the solution is evaporated at 50° C./50 mbar and dried at 50° C./0.2 mbar. Without any further purification a clear yellow liquid is obtained with a yield of 41.0 g (81.8%, purity>90.5%).

MS (Cl): 215 (MH+).

### EXAMPLE 8

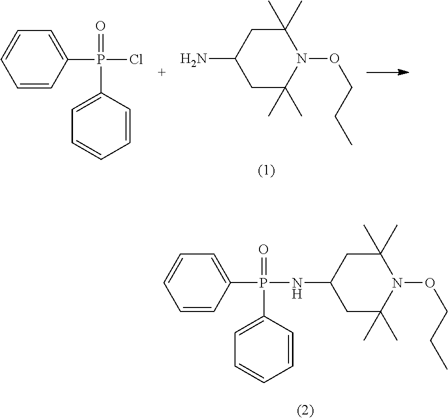 [SMILES: O=P(Cl)(c1ccccc1)c1ccccc1 ; CCCON1C(C)(C)CC(N)CC1(C)C ; CCCON1C(C)(C)CC(NP(=O)(c2ccccc2)c2ccccc2)CC1(C)C]

In a manner analogous to Example 5, 4.68 g (2) are prepared from 4.88 g (1) and 5.5 g diphenylphosphonic chloride and obtained as a white solid. The reaction is carried out in toluene, and triethylamine is used as acid scavenger.

¹H-NMR (300 MHz, CDCl₃): δ 7.2-7.4 (10H), 3.7 (2H), 3.3 (1H), 2.6 (2H), 1.79 (2H), 1.5-1.3 (2H), 1.25 (6H), 1.2 (6H), 0.9 (3H);

IR (neat): vₘₐₓ 3147, 2972, 1438, 1359, 1194, 1184, 1046, 961, 834, 725 [cm⁻¹];

MS (m/z): 415.2 [M⁺H]⁺.

### EXAMPLE 9

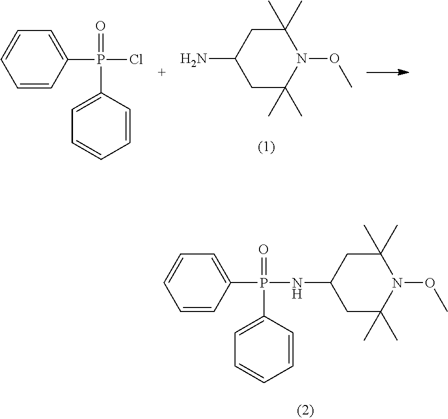 [SMILES: O=P(Cl)(c1ccccc1)c1ccccc1 ; CON1C(C)(C)CC(N)CC1(C)C ; CON1C(C)(C)CC(NP(=O)(c2ccccc2)c2ccccc2)CC1(C)C]

In a manner analogous to Example 5, 3.73 g (2) are prepared from 3.86 g (1) and 5.5 g diphenylphosphonic chloride and obtained as a white solid.

¹H-NMR (300 MHz, CDCl₃): δ 7.2-7.4 (10H), 3.6 (3H), 3.4 (1H), 2.6 (2H), 1.9 (2H), 1.2 (6H), 0.8 (6H);

IR (neat): vₘₐₓ 3170, 2970, 1436, 1359, 1195, 1183, 1035, 964, 832, 723 [cm⁻¹];

MS (m/z) 387.4 [M⁺H]⁺.

### EXAMPLE 10

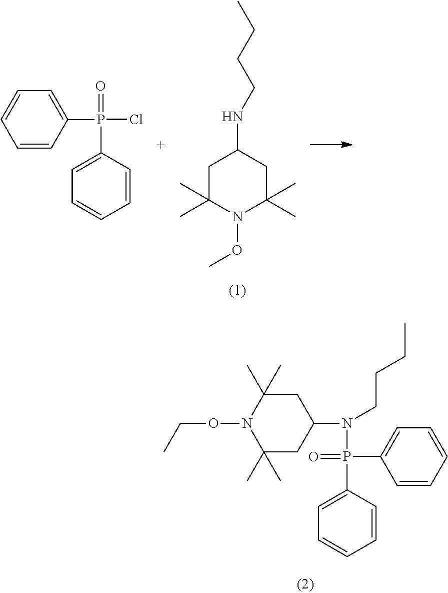

In a manner analogous to Example 5, 6.15 g (2) are prepared from 5.31 g (1) and 5.5 g diphenylphosphonic chloride and obtained as an orange coloured solid.

¹H-NMR (300 MHz, CDCl₃): δ 7.4-7.9 (10H), 3.7 (2H), 3.4 (H), 2.8-3.0 (2H), 2.6 (2H), 1.79 (2H), 1.5-1.3 (4H), 1.25 (6H), 1.2 (6H), 0.7-0.9 (6H);

IR (neat): vₘₐₓ 2974, 2887, 1467, 1438, 1373, 1209, 1193, 1117, 924, 722 [cm⁻¹];

MS (m/z) 457 [M⁺H]⁺.

### EXAMPLE 11

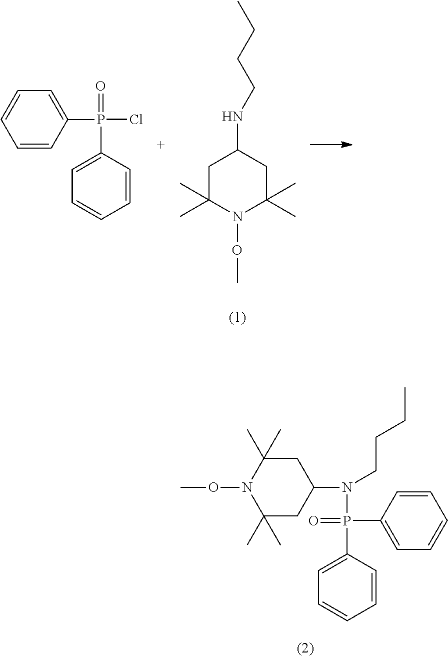

In a manner analogous to Example 5, 6.85 g (2) are prepared from 5.02 g (1) and 5.5 g diphenylphosphonic chloride and obtained as a white solid.

¹H-NMR (300 MHz, CDCl₃): δ 7.4-7.9 (10H), 3.6 (3H), 3.4 (H), 2.8-3.0 (2H), 1.79 (2H), 1.5-1.3 (6H), 1.25 (6H), 1.2 (6H). 0.7-0.9 (3H);

IR (neat): vₘₐₓ 2974, 2887, 1467, 1438, 1373, 1209, 1193, 1117, 924, 722 [cm⁻¹];

MS (m/z) 443.41 [M⁺H]⁺.

### EXAMPLE 12

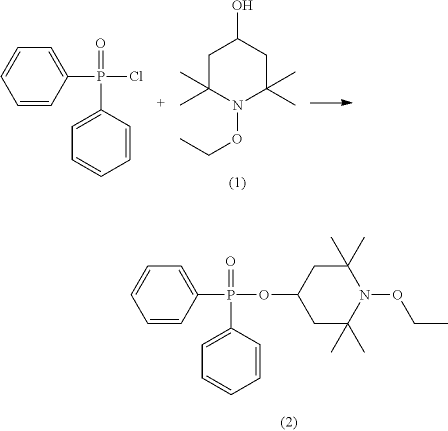

In a manner analogous to Example 5, 8.93 g (2) are prepared from 7.35 g (1) and 9.0 g diphenylphosphonic chloride and obtained as a viscous liquid. The preparation of (1) is described in Example 17 of WO 2008/003602.

¹H-NMR (300 MHz, CDCl₃): δ 7.4-7.9 (10H), 4.6 (1H), 3.7 (2H), 1.6-1.9 (4H), 1.1-1.3 (6H), 0.9-1.1 (9H);

IR (neat): vₘₐₓ 3147, 2972, 1438, 1359, 1194, 1184, 1046, 961, 834, 725 [cm⁻¹];

MS (m/z): 402 [M⁺H]⁺.

### EXAMPLE 13

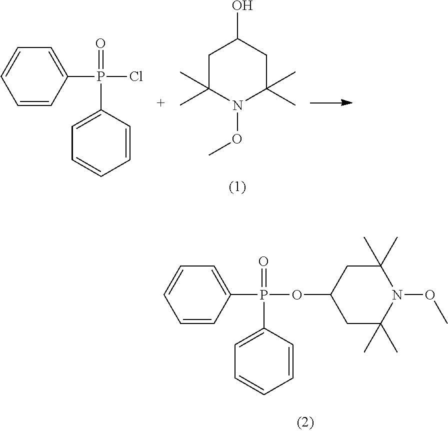

In a manner analogous to Example 5, 3.50 g (2) are prepared from 1.94 g (1) and 9.0 g diphenylphosphonic chloride and obtained as a viscous liquid. The preparation of (1) is described in Example 15 of WO 2008/003602.

¹H-NMR (300 MHz, CDCl₃): δ 7.4-7.9 (10H), 4.6 (1H), 3.6 (3H), 1.6-1.9 (4H), 1.2-1.3 (6H), 0.9-1.1 (6H);

IR (neat): vₘₐₓ 3255, 2988, 1441, 1361, 1258, 1114, 1046, 1013, 963, 817, 730 [cm'];

MS (m/z): 388 [M⁺H]⁺.

### EXAMPLE 14

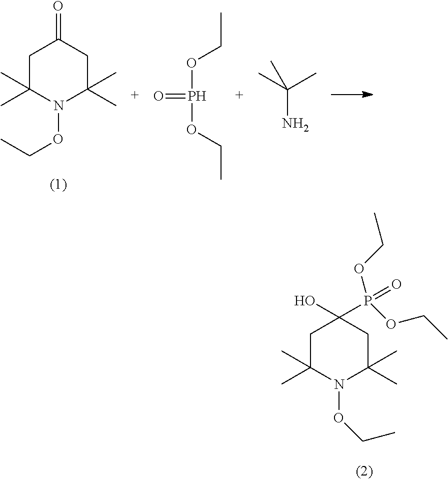

3.58 g (1), 4.96 g diethyl phosphate and 1.31 g tert-butylamine are charged to a three neck round bottom flask under argon atmosphere. The reaction mixture is stirred for 24 h at room temperature. A white solid (2) is isolated by filtration. The product is washed with hexane and dried in an oven at 50° C. for 8 h. The preparation of (1) is described in Example 28 of WO 2008/003602.

¹H-NMR (300 MHz, CDCl₃): δ 4.1-4.3 (4H), 3.7-3.9 (2H), 1.8-2.0 (4H), 1.25 (12H), 1.2 (9H);

IR (neat): vₘₐₓ 3274, 2975, 2924, 1357, 1232, 1175, 1038, 1022, 964, [cm⁻¹];

MS (m/z): 338 [M⁺H]⁺.

### EXAMPLE 15

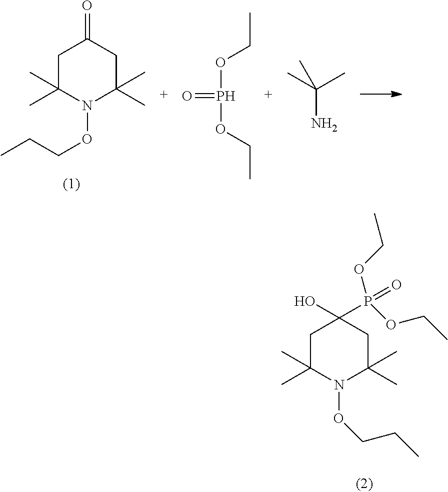

In a manner analogous to Example 15, 3.75 g (2) are prepared from 3.83 g (1) and 9.0 g diethyl phosphite. The preparation of (1) is described in Example 29 of WO 2008/003602.

¹H NMR (300 MHz, CDCl₃): δ 4.1-4.3 (4H), 3.7-3.9 (2H), 1.8-2.0 (6H), 1.3-1.5 (12H), 1.25 (6H), 0.8 (3H);

IR (neat): vₘₐₓ 3276, 2971, 2879, 1466, 1370, 1228, 1056, 1028, 949, 799 [cm⁻¹];

MS (m/z): 352 [M⁺H]⁺.

### EXAMPLE 16

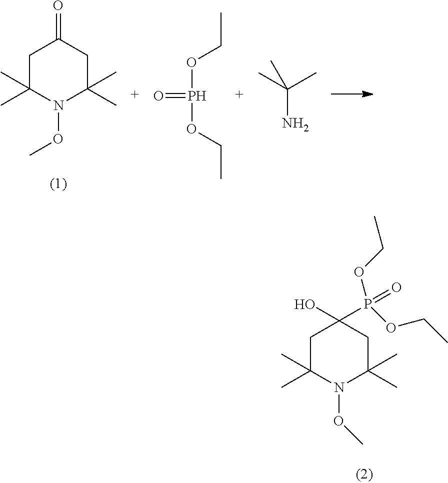

In a manner analogous to Example 15, 3.44 g (2) are prepared from 5.0 g (1) and 6.6 g diethyl phosphite and obtained as a white solid. The preparation of (1) is described in Example 30 of WO 2008/003602.

¹H NMR (300 MHz, CDCl₃): δ 4.1-4.3 (4H), 3.6 (3H), 1.8-2.0 (4H), 1.3-1.5 (12H), 1.25 (6H);

IR (neat): vₘₐₓ 3276, 2971, 2879, 1466, 1370, 1228, 1056, 1028, 949, 799 [cm⁻¹];

MS (m/z): 324.31 [M⁺H]⁺.

### EXAMPLE 17

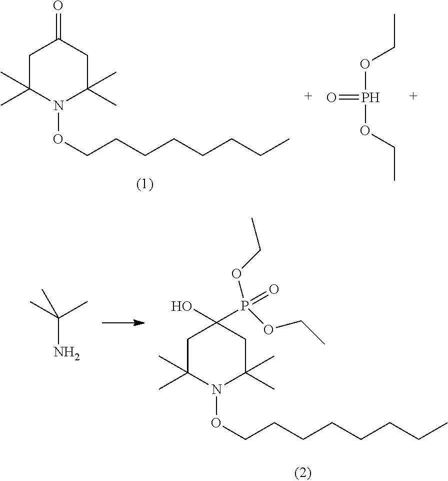

In a manner analogous to Example 15, 1.92 g (2) are prepared from 4.96 g (1) and 6.6 g diethyl phosphite and obtained as a white solid. The preparation of (1) is described in Example 60 of WO 2008/003602.

¹H NMR (300 MHz, CDCl₃): δ 4.1-4.3 (4H), 3.7-3.9 (2H), 1.8-2.0 (4H), 1.5-1.7 (12H), 1.2-1.4 (18H), 0.8 (3H);

IR (neat): vₘₐₓ 3290, 2977, 2931, 1470, 1358, 1230, 1175, 1053, 1025, 953, 725 [cm⁻¹];

MS (m/z): 352[M⁺H]⁺.

### EXAMPLE 18

### 18.1

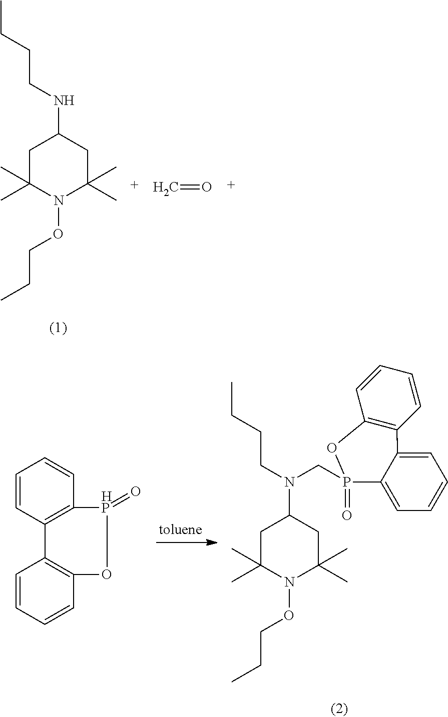

5.56 g 4-N-(n-butyl)amino-1-propoxy-2,2,6,6-tetramethylpiperidine (1) are dissolved in 70 ml toluene. 1.85 g para-formaldehyde and 4.44 g 9,10-dihydro-9-oxa-10-phosphaphenanthrene 10-oxide (CAS Reg. No. 35948-25-5; commercially available from TCI Europe or ABCR) are added. The reaction mixture is heated at 80° C. for 24 h. The mixture is diluted with 100 ml MTBE, washed 3 times with water and dried over sodium sulphate. The solvents are removed under vacuum. The crude product is filtered over silica gel (hexane/ethyl acetate 2:1) and 8.16 g of a pale yellow foam are obtained.

¹H-NMR (300 MHz): 7.87 (3H), 7.60 (1H), 7.41 (1H), 7.35 (1H), 7.12 (2H), 3.61 (1H), 3.53 (2H), 2.62 (2H), 2.30 (2H), 1.41 (4H), 1.20-0.8 (24H);

MS (M⁺H)⁺: 499.

### 18.2

The starting material (1) is prepared from 1-propoxy-4-oxo-tetramethylpiperidine in a manner analogous to Example 2.2.

### EXAMPLE 19

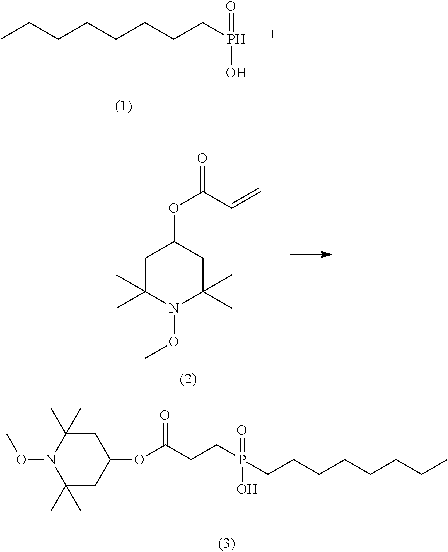

5.17 g (2), 11.45 g (1), 3.20 g dibenzoyl peroxide and 20 ml dioxan are charged to a 250 ml sulphonation flask under argon atmosphere. The reaction mixture is heated to 85° C. for 48 h. The progress of the reaction is monitored by TLC. The reaction mixture is cooled to room temperature and washed with 20% aqueous sodium sulphite solution. Aggregates formed are dissolved in 100 ml ethyl acetate. The organic layer is washed thoroughly with water and finally dried over sodium sulphate. 6.09 g of white solid (MP198° C. dec.) are obtained after removing the solvent under vacuum.

¹H NMR (300 MHz, CDCl₃): δ 3.61 (3H), 2.3 (2H), 1.4-1.9 (8H), 0.8-1.3 (24H), 0.75 (3H);

IR (neat): vₘₐₓ 2975, 2926, 1729, 1468, 1451, 1361, 1242, 1160, 1037, 955, 714 [cm⁻¹];

MS (m/z): 421 [M⁺H]⁺.

B) Application Examples

### Materials and Methods

Commercial polypropylene (Moplen® HF500N, Basell) is extruded in a co-rotating twin-screw extruder (ZSK25, Coperion Werner & Pfleiderer) at a temperature of Tₘₐₓ: 230° C. (heating zones 1-6, throughput rate of 4 kg/h and 100 rpm) and addition of basic level stabilizers [0.3% IRGANOX B225 (1:1-mixture of IRGAFOS 168 and IRGANOX 1010), 0.05% Ca-stearate and the flame retardant additives listed in Table 1. After cooling in water the polymer strand is granulated.

The test specimen are either prepared by compression molding in a hot press (film thickness 200 μm, 250×110 mm, Fontine TP200, pₘₐₓ 50 kN, 230° C.) or by injection molding (100×100 mm plaques, thickness: 1 mm, Arburg 370S, 225° C.

The test samples are tested for flame retardancy in accordance with the method as described in DIN 4102-B2 (40 mm flame length, 200 μm PP films from extrusion (ZSK 18, 190° C.) granules followed by compression molding (230° C.).

Low values indicating burn length and time represent increased efficacy of flame retardancy.

### Results

TABLE

| | | Burn | Burning | |
|---|---|---|---|---|
| Test | | Length | Time | Pass |
| Example | Flame Retardant Additives [0.5%] | [mm] | [sec] | Fail |
| 1 (Control) | w/o | 190 | 48 | Fail |
| 2 | 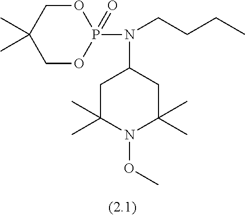 [SMILES: CCCCN(C1CC(C)(C)N(OC)C(C)(C)C1)P1(=O)OCC(C)(C)CO1] | 57 | 10 | Pass |
| 3 | 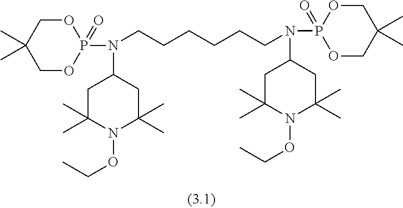 | 56 | 11 | Pass |
| 4 | 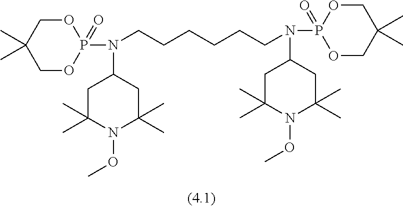 | 52 | 7 | Pass |
| 5 | 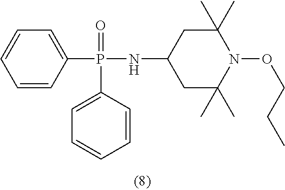 [SMILES: CCCON1C(C)(C)CC(NP(=O)(c2ccccc2)c2ccccc2)CC1(C)C] | 53 | 11 | Pass |
| 6 | 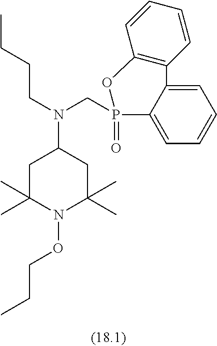 [SMILES: CCCCN(CP1(=O)Oc2ccccc2-c2ccccc21)C1CC(C)(C)N(OCCC)C(C)(C)C1] | 70 | 15 | Pass |

1. A compound of formula (I), 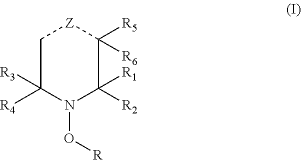
wherein
R represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁-R₄ represent methyl; or
one of R₁ and R₂ and one of R₃ and R₄ represents methyl; and the other ones of R₁ and R₂ and of R₃ and R₄ represent ethyl;
R₅ and R₆ independently of one another represent hydrogen or methyl; and
Z represents a group of partial formula (A) or (C), 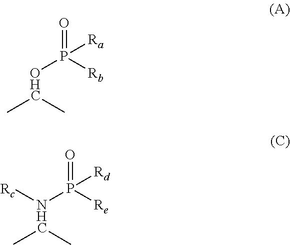
wherein
Rₐ and R_{b} independently of one another represent
C₁-C₄alkyl or C₁-C₄alkoxy;
R_{c} represents hydrogen or C₁-C₁₂alkyl; and
R_{d} and Rₑ independently of one another represent C₁-C₄alkoxy, phenyl or phenoxy; or together represent C₂-C₈alkylenedioxy; or
Z represents a group of partial formula (D), 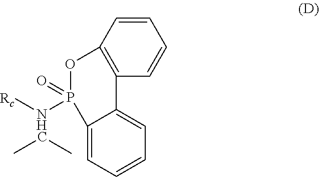
wherein
R_{c} represents hydrogen or C₁-C₁₂alkyl; or
Z represents a group of partial formula (E), 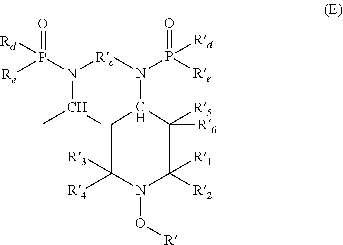
wherein
R_{c}′ represents C₂-C₈alkylene;
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
one of R₁′ and R₂′ and one of R₃′ and R₄′ represents methyl; and the other ones of R₁′ and R₂′ and of R₃′ and R₄′ represent ethyl;
R₅′ and R₆′ independently of one another represent hydrogen or methyl; and
R_{d}′ and Rₑ′ independently of one another represent C₁-C₄alkoxy, phenyl or phenoxy; or
R_{d}′ and Rₑ′ together represent C₂-C₈alkylenedioxy; or
Z represents a group of partial formula (F), 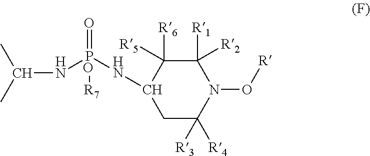
wherein
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
one of R₁′ and R₂′ and one of R₃′ and R₄′ represents methyl; and the other ones of R₁′ and R₂′ and of R₃′ and R₄′ represent ethyl;
R₅′ and R₆′ independently of one another represent hydrogen or methyl; and
R₇ represents phenyl, phenyl-C₁-C₄alkyl; (C₁-C₄alkyl)₁₋₃phenyl or (C₁-C₄alkyl)₁₋₃phenyl-C₁-C₄alkyl.

2. A compound of formula (I), 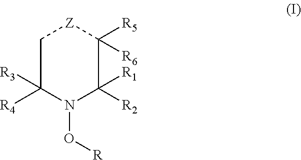
wherein
R represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁-R₄ represent methyl; or
one of R₁ and R₂ and one of R₃ and R₄ represents methyl; and the other ones of R₁ and R₂ and of R₃ and R₄ represent ethyl;
R₅ and R₆ independently of one another represent hydrogen or methyl; and
Z represents a group of partial formula: (A′), (B′) or (C′), 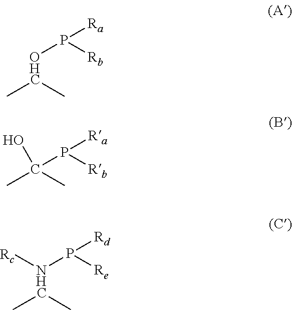
wherein
Rₐ and Rₐ′ and R_{b} and R_{b}′ independently of one another represent
C₁-C₄alkyl, C₁-C₄alkoxy, phenyl or phenoxy;
R_{c} represents hydrogen or C₁-C₁₂alkyl; and
R_{d} and Rₑ independently of one another represent C₁-C₄alkoxy, phenyl or phenoxy; or
Z represents a group of partial formula (D′), 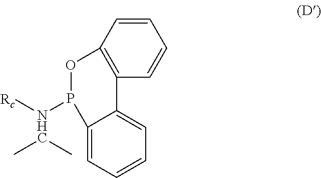
wherein
R_{c} represents hydrogen or C₁-C₁₂alkyl; or
Z represents a group of partial formula (E′), 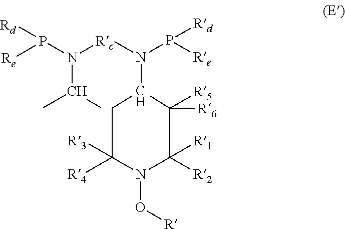
wherein
R_{c}′ represents C₂-C₈alkylene;
R′ represents hydrogen or a substituent selected from the group consisting of C₁-C₁₂alkyl, hydroxy-C₂-C₁₂alkyl, dihydroxy-C₃-C₁₂alkyl, phenyl, phenyl-C₁-C₄alkyl; (C₁-C₄alkyl)₁₋₃phenyl, (C₁-C₄alkyl)₁₋₃phenyl-C₁-C₄alkyl, (C₁-C₄alkoxy)₁₋₃phenyl, (C₁-C₄alkoxy)₁₋₃phenyl-C₁-C₄alkyl, C₃-C₈cycloalkyl, C₃-C₈cycloalkyl-C₁-C₄alkyl, —C(═O)—H, —C(═O)—C₁-C₁₉alkyl and benzoyl;
R₁′-R₄′ represent methyl; or
one of R₁′ and R₂′ and one of R₃′ and R₄′ represents methyl; and the other ones of R₁′ and R₂′ and of R₃′ and R₄′ represent ethyl;
R₅′ and R₆′ independently of one another represent hydrogen or methyl; and
R_{d}′ and Rₑ′ independently of one another represent C₁-C₄alkoxy, phenyl or phenoxy; or
R_{d}′ and Rₑ′ together represent C₂-C₈alkylenedioxy.

3. A compound (I) according to claim 1, wherein
R represents hydrogen or C₁-C₁₂alkyl;
R₁-R₄ represent methyl; and
R₅ and R₆ represent hydrogen.

4. A compound (I) according to claim 1, wherein
R represents hydrogen or C₁-C₁₂alkyl;
R₁-R₄ represent methyl;
R₅ and R₆ represent hydrogen; and
Z represents a group of partial formula (A) or (C),
wherein
Rₐ and R_{b} independently of one another represent C₁-C₄alkoxyl;
R_{c} represents C₁-C₁₂alkyl; and
R_{d} and Rₑ independently of one another represent C₁-C₄alkoxy or phenyl; or
Z represents a group of partial formula (D),
wherein
R_{c} represents C₁-C₁₂alkyl; or
Z represents a group of partial formula (E),
wherein
R_{c}′ represents C₂-C₈alkylene;
R′ represents C₁-C₁₂alkyl;
R₁′-R₄′ represent methyl;
R₅′ and R₆′ represent hydrogen;
and
R_{d}′ and Rₑ′ independently of one another represent C₁-C₄alkoxy or phenyl; or
R_{d}′ and Rₑ′ together represent C₂-C₈alkylenedioxy; or
Z represents a group of partial formula (F),
wherein
R′ represents C₁-C₁₂alkyl;
R₁′-R₄′ represent methyl;
R₅′ and R₆′ represent methyl; and
R₇ represents phenyl.

5. A compound (I) according to claim 1, wherein
R represents C₁-C₈alkyl;
R₁-R₄ represent methyl;
R₅ and R₆ represent hydrogen; and
Z represents a group of partial formula (A) or (C),
wherein
Rₐ and R_{b} represent
C₁-C₄alkoxy;
R_{c} represents C₁-C₈alkyl; and
R_{d} and Rₑ independently of one another represent C₁-C₄alkoxy or phenyl; or
together represent C₂-C₈alkylenedioxy; or
Z represents a group of partial formula (D),
wherein
R_{c} represents C₁-C₈alkyl; or
Z represents a group of partial formula (E),
wherein
R_{c}′ represents C₂-C₈alkylene;
R′ represents C₁-C₁₂alkyl;
R₁′-R₄′ represent methyl;
R₅′ and R₆′ represent hydrogen; and
R_{d}′ and Rₑ′ independently of one another represent C₁-C₄alkoxy or phenyl; or
R_{d}′ and Rₑ′ together represent C₂-C₈alkylenedioxy; or
Z represents a group of partial formula (F),
wherein
R′ represents C₁-C₁₂alkyl;
R₁′-R₄′ represent methyl;
R₅′ and R₆′ represent methyl; and
R₇ represents phenyl.

6. A compound (I) according to claim 1 selected from the group consisting of

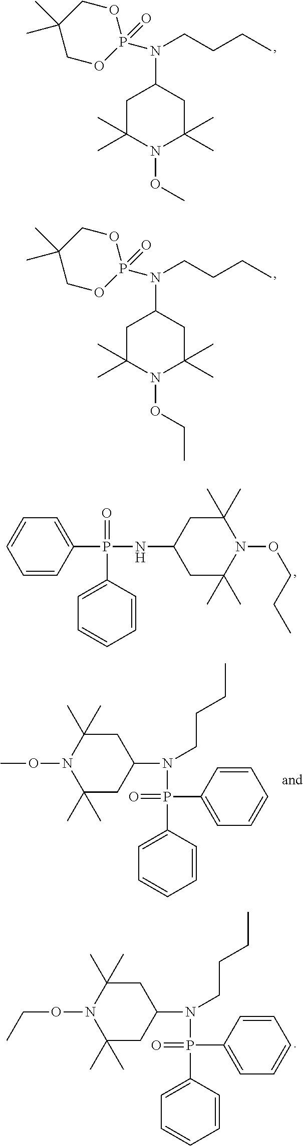

7. The compound (I) according to claim 1 of the formula

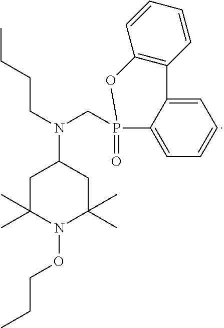 [SMILES: CCCCN(CP1(=O)Oc2ccccc2-c2ccccc21)C1CC(C)(C)N(OCCC)C(C)(C)C1]

8. A compound (I) according to claim 1 selected from the group consisting of

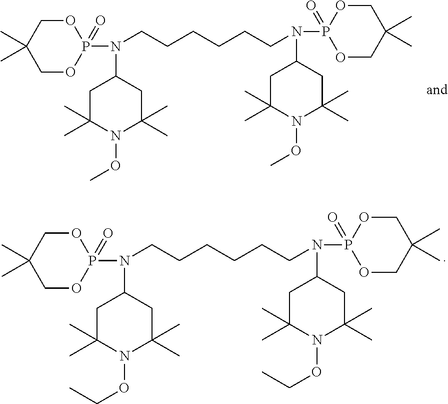

9. A compound (I) according to claim 1 selected from the group consisting of

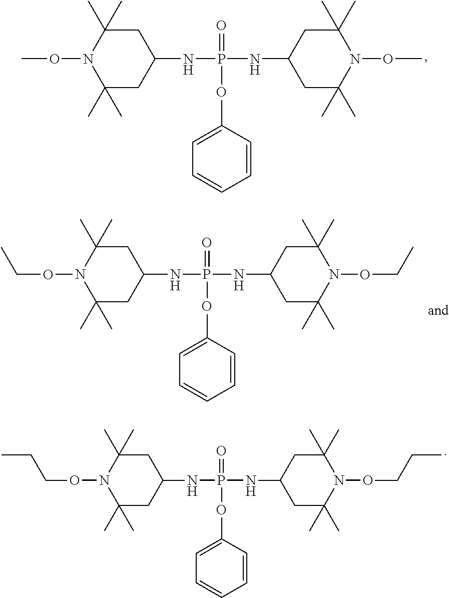

10. A composition which comprises
a) a compound (I) according to claim 1; and
b) a polymer substrate.

11. A composition according to claim 10, which additionally comprises further additives selected from the group consisting of polymer stabilizers, dispersants and additional flame retardants.

12. A process for imparting flame retardancy to a polymer substrate, which process comprises adding to a polymer substrate a compound (I) according to claim 1.
